(19) United States
(12) Patent Application Publication
(10) Pub. No.: US 2023/0101354 A1
(43) Pub. Date: Mar. 30, 2023

(54) METHOD, SYSTEM, AND STORAGE MEDIUM FOR INTELLIGENT ANALYSIS OF STUDENT'S ACTUAL LEARNING BASED ON EXAM PAPER

(71) Applicant: Chongqing Normal University, Chongqing (CN)

(72) Inventors: Xiaohong LAN, Chongqing (CN); Yan MA, Chongqing (CN); Ju PAN, Chongqing (CN); Fuyang Chen, Chongqing (CN)

(21) Appl. No.: 17/806,140

(22) Filed: Jun. 9, 2022

(30) Foreign Application Priority Data
Sep. 27, 2021 (CN) 202111137001.7

(51) Int. Cl. G09B 7/02; G06Q 50/20; G06V 30/413

(52) U.S. Cl. CPC G09B 7/02; G06Q 50/205; G06V 30/413

(57) ABSTRACT

The present disclosure provides a method, a system, and a storage medium for benchmarking-based intelligent analysis of an exam paper. The method includes the following steps: building a curriculum standard knowledge point database by analyzing the subject curriculum standard; and inputting an exam paper by using an image acquisition device, recognizing the exam paper by calling an optical character recognition (OCR) algorithm, building a mathematical model of the exam paper and comparing it with the curriculum standard knowledge base, and generating a personalized study condition diagnosis report. The present disclosure can objectively evaluate how well the examinees master the subject knowledge, so as to provide data support for the examinees to formulate a personalized flexible study plan.

### CROSS REFERENCE TO RELATED APPLICATION

This patent application claims the benefit and priority of Chinese Patent Application No. 202111137001.7, filed on Sep. 27, 2021, the disclosure of which is incorporated by reference herein in its entirety as part of the present application.

### TECHNICAL FIELD

The present disclosure relates to the technical field of exam paper question and answer evaluation, and specifically, to a method, a system, and a storage medium for benchmarking-based intelligent analysis of an exam paper.

### BACKGROUND ART

At present, exam paper analysis is mostly conducted by subject teachers, and they usually focus on the distribution of exam scores of the whole class for one exam. The typical practice is to count the exam scores and per question score of each examinee, and draw an exam score distribution map of the whole class to evaluate the teaching effect. However, such analysis is of little significance to examinees. What the examinees care more about is learning from the exam how well they master the knowledge, so as to allocate more time to the knowledge they have not yet mastered.

Therefore, it is necessary to develop a method, a system, and a storage medium for benchmarking-based intelligent analysis of an exam paper.

### SUMMARY

The present disclosure aims to provide a method, a system, and a storage medium for benchmarking-based intelligent analysis of an exam paper, to provide a visualized study condition diagnosis report, and provide a data basis for designing personalized homework tasks for examinees.

According to the first aspect, a method for benchmarking-based intelligent analysis of an exam paper in the present disclosure includes the following steps:

(1) curriculum standard knowledge base building:

building a curriculum standard knowledge base for each subject and saving the curriculum standard knowledge base as an Excel file, where the curriculum standard knowledge base includes keywords of all knowledge points required by the subject syllabus, and common assessment descriptor keywords for the knowledge points;

(2) exam paper analysis:

(21) exam paper digitization:

inputting an exam paper in picture format, performing recognition to obtain an exam paper recognition result file, preprocessing the recognition result file, filtering out useless data, and saving other data as a .txt file, to obtain an exam paper text file; traversing the exam paper text file, dividing it into several questions, each including a stem, question scores, and examinee's points, and comparing the questions with the subject curriculum standard knowledge base to identify knowledge points of the questions, so as to obtain information of the exam paper, including the knowledge point, score setting, and examinee's points of each question;

(22) exam paper modeling:

using a two-dimensional matrix to digitize the knowledge point, score setting, and examinee's points of each question to generate a question-knowledge point score matrix of the exam paper, where the question-knowledge point score matrix includes the questions set in the exam paper, and syllabus knowledge point, score setting, and examinee's points of each question, to make a question-knowledge point score matrix model for the exam paper; and

(23) model calculation:

carrying out calculation and analysis based on the question-knowledge point score matrix model, and generating a study condition report for the exam paper.

Optionally, the exam paper digitization specifically includes:

(211) exam paper input and recognition

obtaining the exam paper picture, and performing recognition to obtain the exam paper text file;

(212) question partitioning

extracting the subject curriculum standard knowledge base of the exam paper, and forming a curriculum knowledge point vector A={a₁,a₂,a₃, . . . , aₙ} of the exam paper, where a, is a string representing the i-th knowledge point; traversing the exam paper text file, obtaining each question tᵢ in the exam paper through partitioning, extracting a score sᵢ of the question and the examinee's points p₁ for the question, comparing the question tᵢ with the curriculum knowledge point vector A to determine a knowledge point kᵢ for the question, and obtaining a question vector T={t₁,t₂,t₃, . . . , tₘ} of the exam paper, a question score setting vector S={s₁,s₂,s₃, . . . , sₓ}, an examinee's points vector P={p₁,p₂,p₃, . . . , p_{y}}, and a question-related knowledge point vector K={k₁,k₂,k₃, . . . , kₙ} after the traversal is completed.

Optionally, the exam paper modeling specifically includes:

building the question-knowledge point score matrix based on the obtained vectors T, K, S, and P, where the question-knowledge point score matrix is an n×m matrix G=[gₖ_{ᵢ}ₜ_{ⱼ}]_{n×m}, where gₖ_{ᵢ}ₜ_{ⱼ} is the examinee's points ratio of the tⱼ-th question with respect to the kᵢ-th knowledge point, that is, gₖ_{ᵢ}ₜ_{ⱼ}=pⱼ/sⱼ.

Optionally, the study condition report is a bar chart, a curve chart, a pie chart, or a table.

According to the second aspect, a system for benchmarking-based intelligent analysis of an exam paper in the present disclosure is provided, including a memory and a controller, where the memory stores a computer-readable program, and when the computer-readable program is called by the controller, the steps of the method for benchmarking-based intelligent analysis of an exam paper in the present disclosure are performed.

According to the third aspect, a storage medium in the present disclosure is provided, where the storage medium stores a computer-readable program, and when the computer-readable program is called, the steps of the method for benchmarking-based intelligent analysis of an exam paper in the present disclosure are performed.

The present disclosure has the following advantages: for each exam paper, a curriculum standard knowledge base is built according to the subject curriculum standard, the exam paper is recognized by using an optical character recognition (OCR) algorithm, a mathematical model for the exam paper is built, and a visualized study condition diagnosis report is output through benchmarking calculation and analysis of the mathematical model for the exam paper, to provide a data basis for designing personalized homework tasks for examinees.

### BRIEF DESCRIPTION OF THE DRAWINGS

FIG. 1 is a flowchart of an embodiment.

FIG. 2 is schematic diagram of exam paper recognition according to an embodiment.

FIG. 3 is schematic diagram of question partitioning and data extraction according to an embodiment.

FIG. 4 is a schematic diagram of a study condition report in the default bar chart format according to an embodiment.

### DETAILED DESCRIPTION OF THE EMBODIMENTS

The present disclosure will be further described below with reference to the accompanying drawings.

In this embodiment, a method for benchmarking-based intelligent analysis of an exam paper includes the following steps:

(1) curriculum standard knowledge base building:

building a curriculum standard knowledge base for each subject and saving the curriculum standard knowledge base as an Excel file, where the curriculum standard knowledge base includes keywords of all knowledge points required by the subject syllabus, and common assessment descriptor keywords for the knowledge points;

(2) exam paper analysis:

(21) exam paper digitization:

inputting an exam paper in picture format, performing recognition to obtain an exam paper recognition result file, preprocessing the recognition result file, filtering out useless data, and saving other data as a .txt file, to obtain an exam paper text file; traversing the exam paper text file, dividing it into several questions, each including a stem, question scores, and examinee's points, and comparing the questions with the subject curriculum standard knowledge base to identify knowledge points of the questions, so as to obtain information of the exam paper, including the knowledge point, score setting, and examinee's points of each question;

(22) exam paper modeling:

using a two-dimensional matrix to digitize the knowledge point, score setting, and examinee's points of each question to generate a question-knowledge point score matrix of the exam paper, where the question-knowledge point score matrix includes the questions set in the exam paper, and syllabus knowledge point, score setting, and examinee's points of each question, to make a question-knowledge point score matrix model for the exam paper; and

(23) model calculation:

carrying out calculation and analysis based on the question-knowledge point score matrix model, and generating a study condition report for the exam paper.

The following describes each part in this embodiment in detail.

1. curriculum standard knowledge base building

In this embodiment, to better evaluate each exam, a curriculum standard knowledge base (saved as an Excel file) is built for each subject based on the new curriculum standard. The curriculum standard knowledge base includes keywords of all knowledge points required by the subject syllabus, and a common assessment descriptor keyword (which may be a phrase or sentence) for each knowledge point. Data can be added, deleted, and modified to continuously improve the curriculum standard knowledge base. The curriculum standard knowledge base is a main indicator for exam paper evaluation in the system. Therefore, building a scientific and complete curriculum standard knowledge base is the basis and premise of the system. The system can only analyze a subject exam paper for which a curriculum standard knowledge base has been built.

2. Exam paper analysis

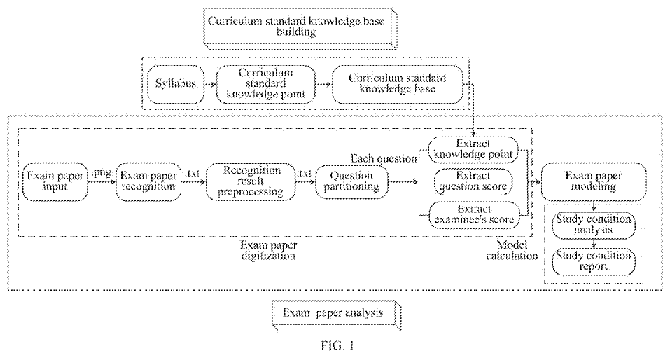

Exam paper analysis is to compare each exam paper with a corresponding subject curriculum standard knowledge base, identify an assessment knowledge point and examinee's points of each question, establish a mathematical model for the exam paper, and perform model calculation to generate an exam paper-based study condition report. As shown in FIG. 1, exam paper analysis mainly includes three stages: exam paper digitization, exam paper modeling, and model calculation.

2.1 exam paper digitization

The exam paper is input in picture format. In this embodiment, the exam paper picture is recognized by calling an OCR interface provided by Baidu AI, to obtain an exam paper recognition result file (a .txt file), the recognition result file is preprocessed to filter out obviously useless data (for example, exam paper description and edge lines), and other data is saved as a .txt file, that is, an exam paper text file. The exam paper text file is traversed and divided into several questions (each including a stem, question score, and examinee's points), and the questions are compared with the subject curriculum standard knowledge base to identify the knowledge points of the questions. In this way, information of the exam paper is obtained: the knowledge point, score setting, and examinee's points of each question, thereby implementing the digitization of the exam paper.

2.2 exam paper modeling

Through the exam paper digitization, the key information of the exam paper has been extracted: the knowledge point, score setting, and examinee's points of each question. Then, such information is digitized by using a two-dimensional matrix, to generate a question-knowledge point score matrix for the exam paper. The question-knowledge point score matrix includes the questions set in the exam paper, and the syllabus knowledge point, score setting, and examinee's points of each question, and is the digital expression of the key information of the exam paper, thereby constructing an effective mathematical model for the exam paper.

2.3 model calculation

Calculation and analysis of different dimensions are performed based on the question-knowledge point score matrix model, to evaluate the exam paper from different angles. For example, the achievement degree of the curriculum standard and coverage of the knowledge points in the assessment can be analyzed based on the questions set in the exam paper. In this embodiment, through exam paper analysis, an objective study condition report is provided for examinees to know how well they master the knowledge points, thereby guiding their later study directions. Therefore, the calculation in this embodiment focuses on how to draw an intuitive study condition report through the model calculation and analysis.

3. This embodiment is described below in detail with reference to examples.

3.1 exam paper digitization

3.1.1 exam paper input and recognition

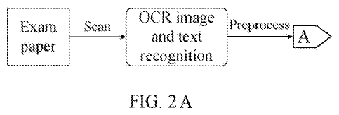

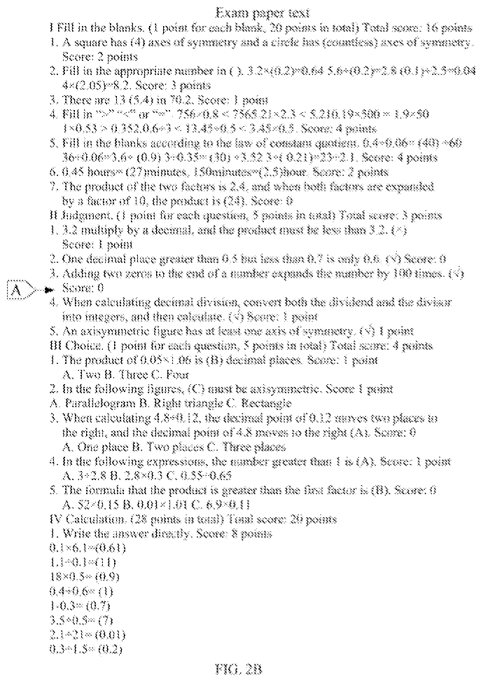

First, the exam paper is input into the system. In this embodiment, the exam paper is input in picture format (.png) by photographing or scanning the exam paper. Whether the content of the exam paper picture can be correctly recognized is directly related to the availability of the exam paper analysis. Since the main content of the exam paper picture is texts, tables, handwriting, and so on, in this embodiment, the exam paper picture is recognized by calling an OCR interface provided by Baidu, to obtain an exam paper text file, as shown in FIG. 2.

3.1.2 question partitioning

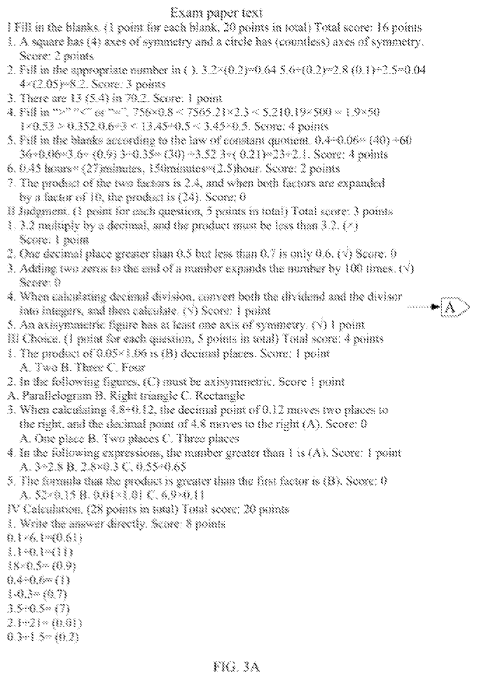

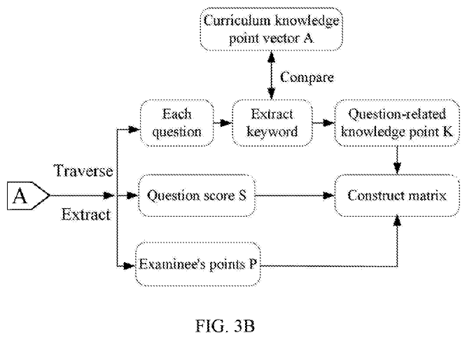

In order to benchmark the subject syllabus, the subject curriculum standard knowledge base for the exam paper is extracted, and a curriculum knowledge point vector A={a₁,a₂,a₃, . . . , aₙ} of the exam paper is formed, where a, is a string representing the i-th knowledge point. The exam paper text file is traversed to obtain each question tᵢ in the exam paper through partitioning, the score sᵢ of the question and the examinee's points pᵢ for the question are extracted, each question tᵢ is compared with the curriculum knowledge point vector A to determine a knowledge point kᵢ for the question, and after the traversal is completed, a question vector T={t₁,t₂,t₃, . . . , tₘ} of the exam paper, a question score setting vector S={s₁,s₂,s₃, . . . , sₓ}, an examinee's points vector P={p₁,p₂,p₃, . . . , p_{y}}, and a question-related knowledge point vector K={k₁,k₂,k₃, . . . , kₙ} are obtained, thereby digitizing key information of the entire exam paper, as shown in FIG. 3.

3.2 mathematical model construction

In this embodiment, to facilitate later study condition analysis, a question-knowledge point score matrix is constructed based on the obtained vectors T, K, S, and P. The matrix reflects the knowledge points of the exam paper and the examinee's points ratio of each knowledge point, and can be analyzed as a mathematical model of the exam paper.

Assuming that the exam paper has n key knowledge points K={k₁,k₂,k₃, . . . , kₙ} distributed in m questions T={t₁,t₂,t₃, . . . , tₘ}, the question-knowledge point score matrix of the exam paper is an n×m matrix G=[gₖ_{ᵢ}ₜ_{ⱼ}]_{n×m}, where gₖᵢₜⱼ is the examinee's points ratio of the tⱼth question with respect to the kᵢ-th knowledge point, that is, gₖ_{ᵢ}ₜ_{ⱼ}=pⱼ/sⱼ. For example, gₜ_{₃}ₖ_{₃}=1/3 means that 3 points of question t₃ in the exam paper are for assessment of knowledge point k₃ (s₃=3), and the examinee only got 1 point (p₃=1). Through the matrix, a knowledge point mastery probability model of the examinee can be established, so as to generate an accurate study condition report for the examinee.

$$G = [ \begin{matrix}Knowledgepoint / Question & {t}_{1} & {t}_{2} & {t}_{3} & … & {t}_{m} \\ {k}_{1} & 0 & 1 / 2 & 0 & … & 1 \\ {k}_{2} & 0 & 0 & 1 & … & 0 \\ {k}_{3} & 1 & 0 & 1 / 3 & … & 0 \\ … & … & … & … & … & … \\ {k}_{n} & 0 & 0 & 1 / 4 & … & 1\end{matrix} ]$$

3.3 study condition analysis

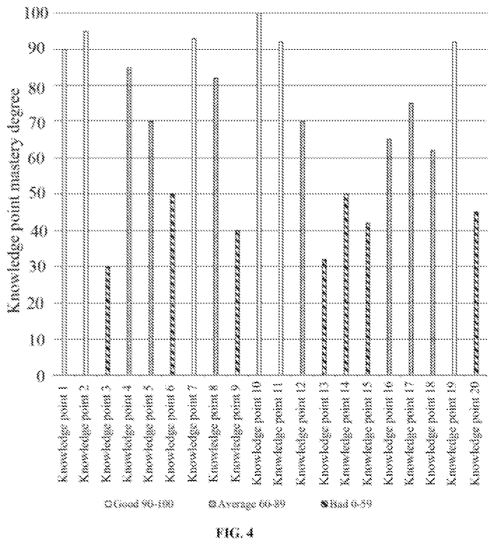

The question-knowledge point score matrix includes the following key information: the knowledge points covered in the exam paper, the questions in the exam paper, the knowledge points of each question, and how well the examinee masters the knowledge points of each question. In this embodiment, the information of the exam paper is visually expressed in the default study condition report format (that is, a bar chart). As shown in FIG. 4, the bar chart is a two-dimensional chart, where the x-axis is all the knowledge points covered in the exam paper, and the y-axis is the mastery degree of the knowledge points of the examinee. Different colored bars are used to represent different mastery degrees of the knowledge points (green: good; yellow: average; red: bad), and a red knowledge point is the content that the examinee should focus on.

In this embodiment, the study condition report may alternatively be in a form of a curve chart, a pie chart, a table, or the like.

After an exam paper is analyzed, a customized study condition report is obtained. The report can clearly show the examinee's mastery of relevant knowledge points, customize the study direction for the examinee, and effectively guide the examinee to check and fill the gaps, thereby reducing pressure and increasing efficiency.

In this embodiment, the method for benchmarking-based intelligent analysis of an exam paper has three distinct features: first, it deeply mines content of the exam paper, and conducts evaluation and analysis strictly with reference to the curriculum standard; second, it flexibly uses an AI recognition algorithm to improve exam paper analysis; and third, it generates a visualized study condition diagnosis report to provide data support for designing personalized homework tasks. The results of applying the system to the analysis of the fifth grade's mathematics exam paper and Chinese exam paper show that the accuracy of the subject curriculum standard knowledge base and the standardization of the exam paper content design are the two main factors that affect the analysis effect. During the use of the system, users can continuously update the subject curriculum standard knowledge base to make it more accurately match the requirements of the curriculum standard, thereby continuously adjusting this influencing factor. The analysis accuracy rate of the system can reach more than 90%, indicating that the exam paper model construction and calculation method proposed in this embodiment is effective and feasible. The method for benchmarking-based intelligent analysis of an exam paper proposed in this embodiment addresses the issue that the conventional exam paper analysis is limited to score statistics and lacks exam paper content analysis.

What is claimed is:

1. A method for benchmarking-based intelligent analysis of an exam paper, comprising the following steps:
(1) curriculum standard knowledge base building:
building a curriculum standard knowledge base for each subject and saving the curriculum standard knowledge base as an Excel file, wherein the curriculum standard knowledge base comprises keywords of all knowledge points required by the subject syllabus, and common assessment descriptor keywords for the knowledge points;
(2) exam paper analysis:
(21) exam paper digitization:
inputting an exam paper in picture format, performing recognition to obtain an exam paper recognition result file, preprocessing the recognition result file, filtering out useless data, and saving other data as a .txt file, to obtain an exam paper text file; traversing the exam paper text file, dividing it into several questions, each comprising a stem, question scores, and examinee's points, and comparing the questions with the subject curriculum standard knowledge base to identify knowledge points of the questions, so as to obtain information of the exam paper, comprising the knowledge point, score setting, and examinee's points of each question;
(22) exam paper modeling:
using a two-dimensional matrix to digitize the knowledge point, score setting, and examinee's points of each question to generate a question-knowledge point score matrix of the exam paper, wherein the question-knowledge point score matrix comprises the questions set in the exam paper, and syllabus knowledge point, score setting, and examinee's points of each question, to make a question-knowledge point score matrix model for the exam paper; and
(23) model calculation:
carrying out calculation and analysis based on the question-knowledge point score matrix model, and generating a study condition report for the exam paper.

2. The method for benchmarking-based intelligent analysis of an exam paper according to claim 1, wherein the exam paper digitization further comprises:
(211) exam paper input and recognition
obtaining the exam paper picture, and performing recognition to obtain the exam paper text file;
(212) question partitioning
extracting the subject curriculum standard knowledge base of the exam paper, and forming a curriculum knowledge point vector A={a₁,a₂,a₃, . . . , aₙ} of the exam paper, wherein a, is a string representing the i-th knowledge point; traversing the exam paper text file, obtaining each question tᵢ in the exam paper through partitioning, extracting a score sᵢ of the question and the examinee's points pᵢ for the question, comparing the question tᵢ with the curriculum knowledge point vector A to determine a knowledge point kᵢ for the question, and obtaining a question vector T={t₁,t₂,t₃, . . . , tₘ} of the exam paper, a question score setting vector S={s₁,s₂,s₃, . . . , sₓ}, an examinee's points vector P={p₁,p₂,p₃, . . . , p_{y}}, and a question-related knowledge point vector K={k₁,k₂,k₃, . . . , kₙ} after the traversal is completed.

3. The method for benchmarking-based intelligent analysis of an exam paper according to claim 2, wherein the exam paper modeling specifically comprises:
building the question-knowledge point score matrix based on the obtained vectors T, K, S, and P, wherein the question-knowledge point score matrix is an n×m matrix G=[gₖ_{ᵢ}ₜ_{ⱼ}]_{n×m}, wherein gₖ_{ᵢ}ₜ_{ⱼ} is the examinee's points ratio of the tⱼ-th question with respect to the kᵢ-th knowledge point, that is, gₖ_{ᵢ}ₜ_{ⱼ}=pⱼ/sⱼ.

4. The method for benchmarking-based intelligent analysis of an exam paper according to claim 1, wherein the study condition report is a bar chart, a curve chart, a pie chart, or a table.

5. The method for benchmarking-based intelligent analysis of an exam paper according to claim 2, wherein the study condition report is a bar chart, a curve chart, a pie chart, or a table.

6. The method for benchmarking-based intelligent analysis of an exam paper according to claim 3, wherein the study condition report is a bar chart, a curve chart, a pie chart, or a table.

7. A system for benchmarking-based intelligent analysis of an exam paper, comprising a memory and a controller, wherein the memory stores a computer-readable program, and when the computer-readable program is called by the controller, the steps of the method for benchmarking-based intelligent analysis of an exam paper according to claim 1 are performed.

8. The system for benchmarking-based intelligent analysis of an exam paper according to claim 7, wherein the exam paper digitization further comprises:
(211) exam paper input and recognition
obtaining the exam paper picture, and performing recognition to obtain the exam paper text file;
(212) question partitioning
extracting the subject curriculum standard knowledge base of the exam paper, and forming a curriculum knowledge point vector A={a₁,a₂,a₃, . . . , aₙ} of the exam paper, wherein aᵢ is a string representing the i-th knowledge point; traversing the exam paper text file, obtaining each question tᵢ in the exam paper through partitioning, extracting a score sᵢ of the question and the examinee's points pᵢ for the question, comparing the question tᵢ with the curriculum knowledge point vector A to determine a knowledge point kᵢ for the question, and obtaining a question vector T={t₁,t₂,t₃, . . . , tₘ} of the exam paper, a question score setting vector S={s₁,s₂,s₃, . . . , sₓ}, an examinee's points vector P={p₁,p₂,p₃, . . . p_{y}}, and a question-related knowledge point vector K={k₁,k₂,k₃, . . . , kₙ} after the traversal is completed.

9. The system for benchmarking-based intelligent analysis of an exam paper according to claim 8, wherein the exam paper modeling specifically comprises:
building the question-knowledge point score matrix based on the obtained vectors T, K, S, and P, wherein the question-knowledge point score matrix is an n×m matrix G=[gₖ_{ᵢ}ₜ_{ⱼ}]_{n×m}, wherein gₖ_{ᵢ}ₜ_{ⱼ} is the examinee's points ratio of the tⱼ-th question with respect to the kᵢ-th knowledge point, that is, gₖ_{ᵢ}ₜ_{ⱼ}=pⱼ/sⱼ.

10. The system for benchmarking-based intelligent analysis of an exam paper according to claim 7, wherein the study condition report is a bar chart, a curve chart, a pie chart, or a table.

11. The system for benchmarking-based intelligent analysis of an exam paper according to claim 8, wherein the study condition report is a bar chart, a curve chart, a pie chart, or a table.

12. The system for benchmarking-based intelligent analysis of an exam paper according to claim 9, wherein the study condition report is a bar chart, a curve chart, a pie chart, or a table.

13. A storage medium, storing a computer-readable program, wherein when the computer-readable program is called, the steps of the method for benchmarking-based intelligent analysis of an exam paper according to claim 1 are performed.

14. The storage medium according to claim 13, wherein the exam paper digitization further comprises:
(211) exam paper input and recognition
obtaining the exam paper picture, and performing recognition to obtain the exam paper text file;
(212) question partitioning
extracting the subject curriculum standard knowledge base of the exam paper, and forming a curriculum knowledge point vector A={a₁,a₂,a₃, . . . , aₙ} of the exam paper, wherein a, is a string representing the i-th knowledge point; traversing the exam paper text file, obtaining each question tᵢ in the exam paper through partitioning, extracting a score sᵢ of the question and the examinee's points pᵢ for the question, comparing the question tᵢ with the curriculum knowledge point vector A to determine a knowledge point kᵢ for the question, and obtaining a question vector T={t₁,t₂,t₃, . . . , tₘ} of the exam paper, a question score setting vector S={s₁,s₂,s₃, . . . , sₓ}, an examinee's points vector P={p₁,p₂,p₃, . . . , p_{y}}, and a question-related knowledge point vector K={k₁,k₂,k₃, . . . , kₙ} after the traversal is completed.

15. The storage medium according to claim 14, wherein the exam paper modeling specifically comprises:
building the question-knowledge point score matrix based on the obtained vectors T, K, S, and P, wherein the question-knowledge point score matrix is an n×m matrix G=[gₖ_{ᵢ}ₜ_{ⱼ}]_{n×m}, wherein gₖ_{ᵢ}ₜ_{ⱼ} is the examinee's points ratio of the tⱼ-th question with respect to the kᵢ-th knowledge point, that is, gₖ_{ᵢ}ₜ_{ⱼ}=pⱼ/sⱼ.

16. The storage medium according to claim 13, wherein the study condition report is a bar chart, a curve chart, a pie chart, or a table.

17. The storage medium according to claim 14, wherein the study condition report is a bar chart, a curve chart, a pie chart, or a table.

18. The storage medium according to claim 15, wherein the study condition report is a bar chart, a curve chart, a pie chart, or a table.
